(19) United States
(12) Patent Application Publication
(10) Pub. No.: US 2024/0217069 A1
(43) Pub. Date: Jul. 4, 2024

(54) HOLDING SEGMENT FOR A WORKPIECE HOLDING DEVICE, WORKPIECE HOLDING DEVICE AND MACHINE TOOL

(71) Applicant: HOMAG Bohrsysteme GmbH, Herzebrock-Clarholz (DE)

(72) Inventors: Werner DÜPJOHANN, Herzebrock-Clarholz (DE); Stephan WIGGERINGLOH, Warendorf (DE); Vera ZIMMERMANN, Bad Rippoldsau-Schapbach (DE); Roland ORTKRAS, Herzebrock-Clarholz (DE); Andre BENDLAGE, Guetersloh (DE); Martin GRINGEL, Strassberg (DE)

(73) Assignee: HOMAG Bohrsysteme GmbH, Herzebrock-Clarholz (DE)

(21) Appl. No.: 18/558,059

(22) PCT Filed: May 17, 2022
(86) PCT No.: PCT/EP2022/063305

§ 371 Date: Oct. 30, 2023

(30) Foreign Application Priority Data
May 18, 2021 (DE) 10 2021 112 807.2

(51) Int. Cl. B25B 11/00

(52) U.S. Cl. CPC B25B 11/005

(57) ABSTRACT

A holding segment for a workpiece holding device, includes: a support plate with openings, a distribution member including at least one fluid channel, the distribution member being provided for fluid connection to at least one supply line, a plurality of valves for fluidly connecting the fluid channel of the distribution member to the openings of the support plate, in which each of the valves can be separately turned on/off.

### TECHNICAL FIELD

The invention relates to a holding segment for a workpiece holding device as well as to a workpiece holding device configured to receive a workpiece. The invention furthermore relates to a machine tool comprising a workpiece holding device, which is configured in particular for machining plate-shaped workpieces.

### PRIOR ART

In order to divide a plate-shaped workpiece, so-called nesting machines are, for example, used, with which an initial workpiece can be divided into a plurality of partial workpieces. In order to divide the initial workpiece, a milling unit is used, which engages with the workpiece that is held on a clamping table. During the separation process, the milling unit follows the corresponding cutting contours in a waste-optimised manner.

In this context, it is known to arrange a protective plate between the clamping table and the initial workpiece, which acts as a wear plate. The parts can thus be completely cut out of the initial workpiece by slightly inserting the milling tool into the protective plate. A further function of the protective plate is to act as a vacuum distribution system between the surface of the clamping table and the underside of the workpiece.

A calibration process of the protective plate is usually required after a certain number of machining operations. This reduces productivity, and the protective plate causes additional expense for the procurement and handling thereof. However, this method has proven itself in industry.

In known nesting machines, an integrated vacuum distribution system is used on the clamping table, which system is divided into zones in order to supply vacuum to individual regions of the table. The clamping of workpieces can thus be adapted to different dimensions of the workpieces according to the occupancy of the table. The construction effort increases with the number of zones available for a table since the corresponding installation technology is comparatively complex. The clamping table is in particular configured such that each zone is separately provided with a supply system. The vacuum performance of the clamping table of a nesting machine is configured in such a manner that a certain vacuum performance must be ensured at all times during clamping of the workpiece, for example 60% of the nominal vacuum. The vacuum requirement increases proportionally with the table size. This aspect must be taken into account when configuring the vacuum performance.

### DESCRIPTION OF THE INVENTION

An object of the invention is to provide a device for holding a workpiece that has a simplified construction.

This is made possible by the holding segment for a workpiece holding device according to claim 1. Further preferred embodiments are specified in the dependent claims. A workpiece holding device and a machine tool comprising a workpiece holding device are furthermore proposed.

The holding segment suitable for a workpiece holding device comprises: a support plate with openings, a distribution member comprising at least one fluid channel, said distribution member being provided for fluid connection to at least one supply line, and a plurality of valves for fluidly connecting the fluid channel of the distribution member to the openings of the support plate, it being possible to separately turn each of the valves on/off.

Since the holding segment for the workpiece holding device is suitable for a modular construction or since the workpiece holding device is modularly constructed, in particular comprises a plurality of holding segments, the workpiece holding device can be adapted in accordance with the required dimensions. This allows a high degree of flexibility in the design and manufacture of such a workpiece holding device. By using similar or identical holding segments, prefabrication focused on a defined number of work steps can be implemented.

The workpiece holding device is in particular suitable for holding one or more workpieces to be divided (nesting process).

It is preferred that the support plate is provided with a sealing device that divides the holding segment into holding regions. The holding segment can thus be divided into a plurality of sections.

It is preferred that the distribution member comprises a groove that forms the at least one fluid channel. Such a distribution member can be integrated into the construction in a space-saving manner.

It is preferred that the holding segment comprises a support member disposed between the support plate and the distribution member, said support member having a plurality of openings to provide a fluid connection between the distribution member and the openings of the support plate. By means of the support member, a seal can be provided to the support plate.

It is preferred that the support plate comprises a surface provided with grooves. A negative pressure can be evenly distributed by means of the grooves such that a particularly secure hold and support for a workpiece, in particular a plate-shaped workpiece, is ensured.

It is furthermore preferred that the support plate has a rubberised surface. The rubberised surface ensures a particularly advantageous seal to a workpiece. Additional slip resistance is furthermore ensured, which has proven to be advantageous in particular when machining plate-shaped workpieces, for example in the nesting process. The rubberised surface can be configured in such a manner that nesting machining can be performed without an additional protective plate.

According to a further embodiment, the distribution member comprises a first fluid channel and a second fluid channel. The fluid channels can be used to provide different pressure levels. The scope of application of the holding segment can thus be significantly increased.

According to one embodiment, the holding segment comprises a fluid pressure detection device. In this manner, occupancy of the holding segment or sections thereof can be monitored.

Further provided is a workpiece holding device that is configured to receive a workpiece and comprises a plurality of holding segments. The holding segments can be configured according to one of the aspects specified above. The holding segments of the workpiece holding device comprise the following features: a support plate with openings, a distribution member comprising at least one fluid channel, said distribution member being fluidly connected to at least one supply line, as well as a plurality of valves for fluidly connecting the distribution member to the openings of the support plate, it being possible to separately turn each of the valves on/off.

It is preferred that adjacent holding segments are connected to one another by means of a plug connection. This facilitates the construction of different workpiece holding devices with such holding segments, and thus significant cost advantages are also made possible at the same time as a flexible configuration.

The holding segments may substantially have the same length and/or width. The individual holding segments can thus be manufactured in large quantities and be individually assembled for a specific workpiece holding device.

According to a further embodiment, it is provided that at least one of the holding segments is movable in a vertical direction such that the holding segment provides a lifting function. A workpiece held by the holding segment can, for example, be machined more easily on a side surface (for instance on the narrow surface in the case of a plate-shaped workpiece).

According to a further aspect, the invention provides a machine tool that is in particular suitable for machining plate-shaped workpieces. The machine tool comprises: a holding segment according to any one of the aforementioned aspects or a workpiece holding device according to any one of the aforementioned aspects. The machine tool furthermore comprises at least one negative pressure generating device.

According to a further embodiment, the machine tool comprises a first negative pressure generating device for generating a first negative pressure level and a second negative pressure generating device for generating a second negative pressure level. The scope of application of the machine tool can thus be significantly increased since a specific negative pressure level can be used as required.

The machine tool may furthermore comprise a control device configured to control a fluid connection between one of the low pressure generating devices and the support plate of a holding segment, in particular by turning one or more of the valves on or off. According to this embodiment, a specific negative pressure level can be individually provided.

Further provided is a use of a holding segment for a workpiece holding device, a use of a workpiece holding device and a use of a machine tool according to any one of the aforementioned aspects for holding a workpiece, in particular a plate-shaped workpiece.

Such a workpiece may, for example, be a workpiece made of wood, a wood material, plastic, gypsum, composite material, cement fibre or the like.

The machine tool preferably comprises a milling unit. The milling unit can be provided on a movable unit, the milling unit preferably being mounted on a carriage that can be moved in a horizontal and/or vertical direction relative to the movable unit. The machine tool is thus preferably configured for dividing a workpiece.

### BRIEF DESCRIPTION OF THE DRAWINGS

Further features and advantages of a workpiece holding device as well as a machine tool according to an embodiment of the invention are apparent from the following description with reference to the accompanying figures.

FIG. 1 shows a perspective view of a machine tool that comprises a workpiece holding device.

FIG. 2a shows a holding segment of a workpiece holding device according to FIG. 1.

FIG. 2b shows a support member of a holding segment according to FIG. 2a.

FIG. 3 shows a holding segment of a workpiece holding device according to a further embodiment.

### DESCRIPTION OF EMBODIMENTS

Identical reference numbers that are used in different figures designate identical, corresponding or functionally similar elements.

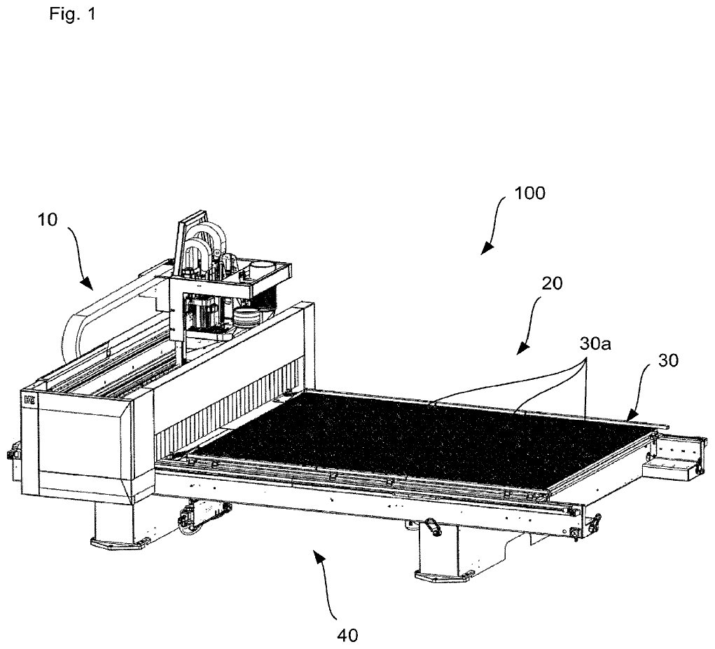

FIG. 1 shows a perspective view of an embodiment of a machine tool 100 configured for machining in particular plate-shaped workpieces. The machine tool 100 is in particular provided for dividing workpieces in the so-called nesting process.

Such a workpiece may, for example, be a workpiece made of wood, a wood material, plastic, gypsum, composite material, cement fibre or the like, such as used in the furniture and components industry.

The machine tool 100 comprises a movable unit 10 that can be moved along a machine bed 20. The machine bed 20 comprises a support unit 40 as well as a workpiece holding device 30 provided on the support unit 40. The workpiece holding device 30 forms a horizontal plane on which a workpiece can be placed.

The workpiece holding device 30 comprises a plurality of holding segments 30a arranged next to one another and connected with one another to form the plane on which a workpiece can be placed. The holding segments 30a comprise a support plate 31 having a surface provided with grooves to guide a negative pressure/vacuum for holding a workpiece into various regions of the holding segment 30a. For this purpose, openings 31a are provided in a support plate 31 of a respective holding segment 30a, which can be fluidly connected to a negative pressure source.

A holding segment 30a is furthermore divided into holding regions 31b by a sealing device 32 provided on the support plate 31. The sealing device 32 is also referred to as a skeleton seal. In the embodiment example, each of the holding regions 31b comprises eight openings 31a.

A support member 33 is disposed underneath the support plate 31 of the holding segment 30a, by means of which support member 33 the support plate 31 is sealed. The support member 33 comprises a plurality of openings 33a.

A distribution member 35 is arranged underneath the support member 33 in the vertical direction, which provides a fluid channel 35a that leads into the region of the openings 33a. A fluid connection between the distribution member 35 and the openings 33a as well as the openings 31a is provided by a plurality of valves 36, it being possible to separately turn each of the valves 36 on/off.

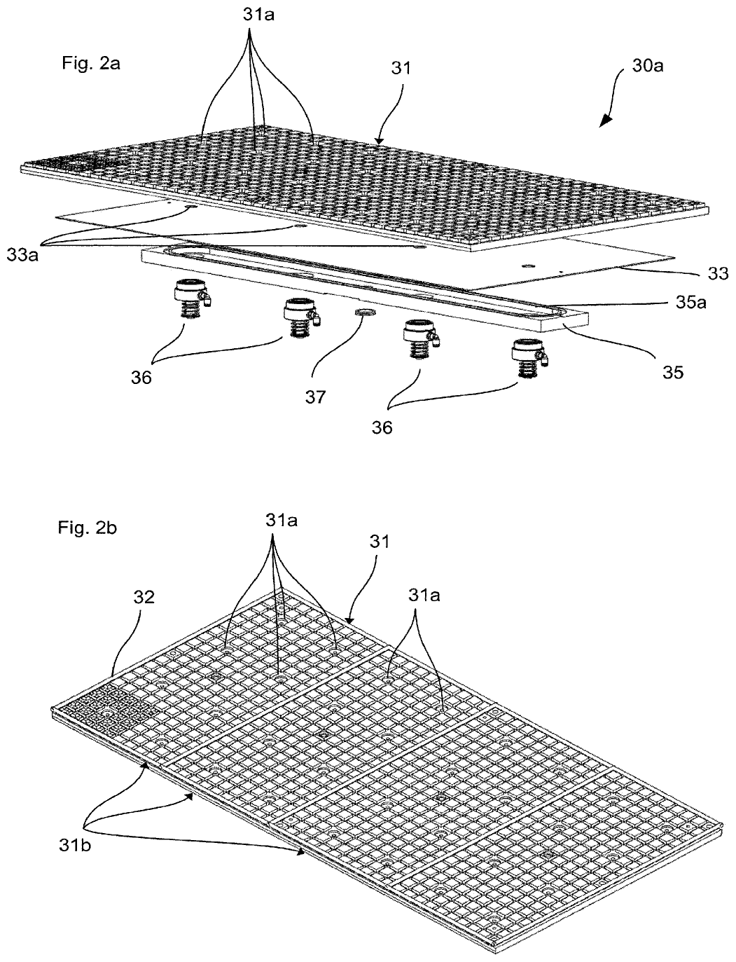

A supply of negative pressure (vacuum) to the distribution member 35 is achieved by means of a supply line 37 (the supply line 37 is only schematically indicated in FIG. 2a).

Since the workpiece holding device 30 is modularly constructed, and in particular comprises a plurality of holding segments 30a with correspondingly associated distribution members 35, the workpiece holding device 30 can be adapted in accordance with the required dimensions. The respective holding segments 30a may be combined accordingly to form the workpiece holding device 30.

Due to the modular design and the holding segments 30a configured in specific dimensions, a high degree of flexibility can be realised at comparatively low manufacturing costs. The respective holding segments 30a may already be equipped with integrated valves 36 as well as corresponding sensor technology, which are prefabricated in the course of pre-assembly.

The holding segments 30a can be connected when completing the workpiece holding device 30.

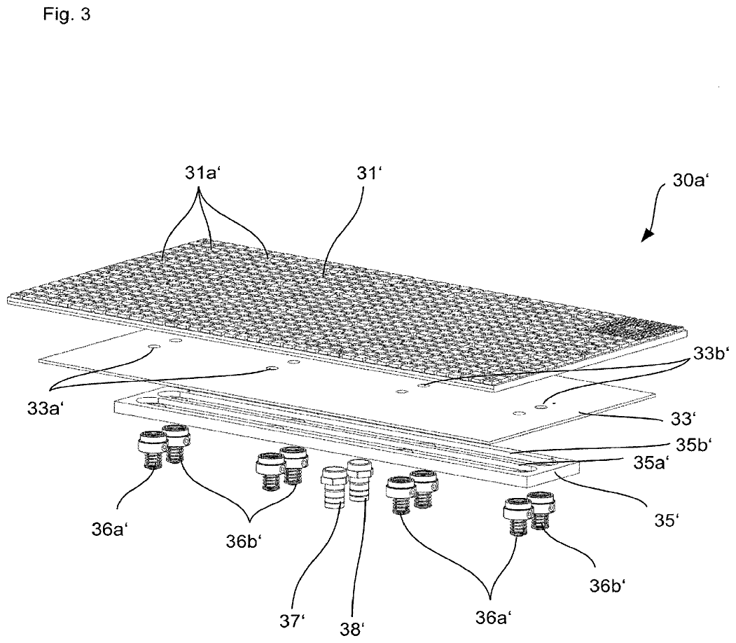

A second embodiment is described with the aid of FIG. 3. According to the second embodiment, a distribution member 35′ of a respective holding segment 30a′ comprises two fluid channels, one of the fluid channels being provided for a high vacuum and another of the fluid channels being provided for a low vacuum. A machine tool equipped with such a holding segment 30a′ may comprise two negative pressure generating devices, one of the negative pressure generating devices being configured to generate a high vacuum and another negative pressure generating device being configured to generate a low vacuum.

Alternatively, the machine tool can also be provided with different negative pressure levels.

The holding segment 30a′ according to the second embodiment comprises a support plate 31′ having a surface provided with grooves. The support plate 31′ furthermore comprises opening 31a′ for supplying negative pressure into the grooved surface of the support plate 31′.

The holding segment 30a′ is divided into holding regions by a sealing device (not shown, but configured in a similar manner to the sealing device 32 in the first embodiment) provided on the support plate 31 (see also holding regions 31b of the first embodiment). The sealing device is also referred to as a skeleton seal.

A support member 33′ is provided underneath the support plate 31′ of the holding segment 30a′, the support member 33′ comprising a plurality of openings 33a′, 33b′, a first group of openings 33a′ being for providing high vacuum and a second group of openings 33b′ being for providing low vacuum.

The holding segment 30a′ furthermore comprises the aforementioned distribution member 35′, which is arranged on the side of the support member 33′ facing away from the support plate 31′. The distribution member 35′ comprises two fluid channels, a first supply line 37′ being assigned to a first fluid channel 35a′ and a second supply line 38′ being assigned to a second fluid channel 35b′.

The holding member 30a′ furthermore comprises a plurality of valves 36a′, 36b′, a first group of valves 36a′ providing a connection between the first fluid channel 35a′ of the distribution member 35′ and the first openings 33a′, and a second group of valves 36b′ providing a connection between the second fluid channel 35b′ of the distribution member 35′ and the second openings 33b′. Each of these valves can be separately turned on/off.

Similar to the workpiece holding device 30 of the first embodiment, the workpiece holding device 30′ of the second embodiment is also modularly constructed. By connecting a plurality of holding segments 30a′, the workpiece holding device 30′ can be configured according to the required dimensions. The correspondingly configured holding segments 30a′ allow a high degree of flexibility at comparatively low manufacturing costs. The holding segments 30a′ may in particular already be equipped with integrated valves as well as corresponding sensor technology in the course of a pre-assembly. The holding segments can be connected by means of a plug system when completing the workpiece holding device 30′.

As regards further aspects of the workpiece holding device 30′ of the second embodiment, reference is additionally made to the explanations provided with respect to the first embodiment. Similar to the first embodiment, the support plate 31′ is in particular provided with a sealing device (see in this regard sealing device 32 according to the first embodiment) to divide the support plate 31′ into holding regions.

In addition, according to a modification of the embodiment, it is possible to provide individual or all holding segments with a lifting function to enable horizontal machining of the respective workpiece.

A fluid pressure detection device (a fluid pressure sensor) may be integrated into a holding segment according to any of the preceding embodiments in order to monitor an occupancy of the holding segment, or sections thereof.

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. A holding segment for a workpiece holding device, comprising:
a support plate with openings,
a distribution member comprising at least one fluid channel, said distribution member being provided for fluid connection to at least one supply line,
a plurality of valves for fluidly connecting the fluid channel of the distribution member to the openings of the support plate, wherein each of the valves can be separately turned on/off.

2. The holding segment according to claim 1, wherein the support plate is provided with a sealing device that divides the holding segment into holding regions.

3. The holding segment according to claim 1, wherein the distribution member comprises a groove that forms the at least one fluid channel.

4. The holding member according to claim 1, further comprising a support member disposed between the support plate and the distribution member, wherein said support member comprises a plurality of openings to provide a fluid connection between the distribution member and the openings of the support plate.

5. The holding segment according to claim 1, wherein the support plate comprises a surface provided with grooves.

6. The holding segment according to claim 1, wherein the distribution member comprises a first fluid channel and a second fluid channel.

7. The holding segment according to claim 1, further comprising a fluid pressure detection device.

8. A workpiece holding device configured to receive a workpiece, comprising a plurality of holding segments, each of said holding segments comprising:
a support plate with openings,
a distribution member comprising at least one fluid channel, said distribution member being fluidly connected to at least one supply line, and
a plurality of valves for fluidly connecting the distribution member to the openings of the support plate, wherein each of the valves can be separately turned on/off.

9. The workpiece holding device according to claim 8, wherein adjacent holding segments are connected to one another by means of a plug connection.

10. The workpiece holding device according to claim 8, wherein the holding segments have substantially the same length and/or width.

11. The workpiece holding device according to claim 8, wherein at least one of the holding segments is movable in a vertical direction.

12. A machine tool for machining plate-shaped workpieces, comprising a holding segment according to claim 1, wherein said machine tool comprises at least one negative pressure generating device.

13. The machine tool according to claim 12, comprising a first negative pressure generating device for generating a first negative pressure level and a second negative pressure generating device for generating a second negative pressure level.

14. A machine tool according to claim 13, comprising a control device configured to control a fluid connection between one of the negative pressure generating devices and the support plate of a holding segment, in particular by turning one or more of the valves on or off.

15. The holding segment according to claim 5, wherein the support plate has a rubberised surface.

16. A machine tool for machining plate-shaped workpieces, comprising a workpiece holding device according to claim 8, wherein said machine tool comprises at least one negative pressure generating device.
